(19) United States
(12) Patent Application Publication
(10) Pub. No.: US 2012/0155966 A1
(43) Pub. Date: Jun. 21, 2012

(54) GAS AND LIQUID RECOVERY FROM REGOLITH

(75) Inventors: Andrew J. Zillmer, West Hills, CA (US); Cheng-Yi Lu, West Hills, CA (US)

(73) Assignee: HAMILTON SUNDSTRAND CORPORATION, Windsor Locks, CT (US)

(21) Appl. No.: 12/974,199

(22) Filed: Dec. 21, 2010

(51) Int. Cl. B01D 57/00

(52) U.S. Cl. 405/128.85

(57) ABSTRACT

A resource recovery system includes a capture container located at a desired surface defining a capture volume between the surface and an interior of the capture container. One or more hole-making devices are configured to excavate soil from at least one hole in the surface. One or more energy emitters direct energy toward the excavated soil to heat the excavated soil thereby releasing one or more compounds. The capture container is configured to capture gas and/or liquid compounds released from the excavated soil. A method of resource extraction from soil includes covering a desired surface with a capture container defining a capture volume between the desired surface and an interior of the capture container. Soil is excavated from a hole in the desired surface into the capture volume. The excavated soil is heated via one or more energy emitters thereby releasing one or more compounds into the capture volume.

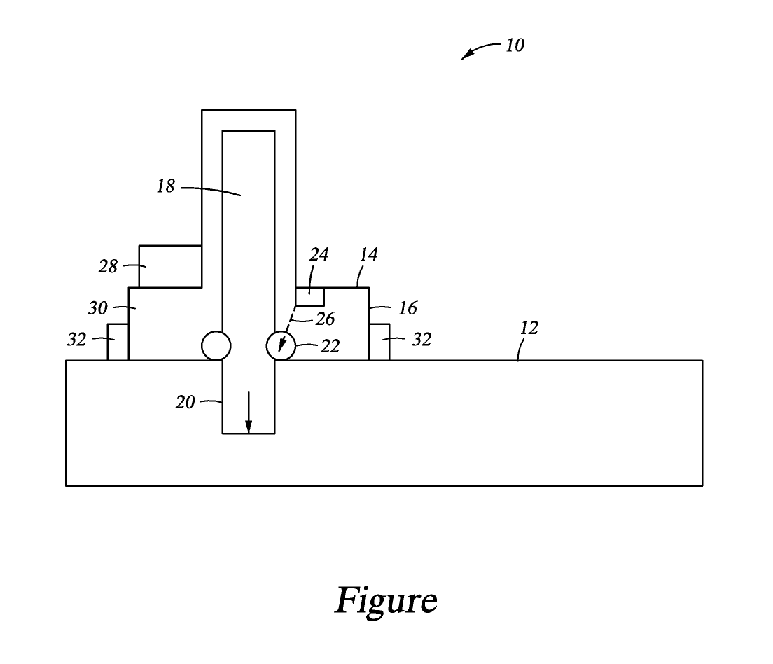

### BACKGROUND OF THE INVENTION

The subject matter disclosed herein relates to resource recovery. More specifically, the subject disclosure relates gas and liquid resource recovery from regolith.

Regolith is a layer of loose, heterogeneous material covering solid rock. It includes dust, soil, broken rock, and other related materials and is present on Earth, the Moon, some asteroids, and other planets. Transportation of fuel and other resources to locations such as the Moon for use on the Moon and/or for a return trip to Earth adds mass and complexity to the craft carrying the resources and the mission in general which much address storage and handling of the resources. Systems and methods to extract gas and/or liquid resources from a regolith surface of, for example, the Moon, for use on site would be desired to enable faster missions or to enable more equipment to be transported on the mission in place of the fuel or other resources that would ordinarily be transported.

### BRIEF DESCRIPTION OF THE INVENTION

According to one aspect of the invention, a resource recovery system includes a capture container defining a capture volume between a desired surface and an interior of the capture container. One or more hole-making devices are located in the capture container configured to excavate soil from at least one hole in the desired surface. One or more energy emitters configured to direct energy toward the excavated soil to heat the excavated soil thereby releasing one or more compounds. The capture container is configured to capture gas and/or liquid compounds released from the excavated soil.

According to another aspect of the invention, a method of resource extraction from soil includes covering a desired surface with a capture container defining a capture volume between the desired surface and an interior of the capture container. Soil is excavated from a hole in the desired surface into the capture volume.

The excavated soil is heated via one or more energy emitters thereby releasing one or more compounds into the capture volume.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

The FIGURE is a schematic view of an embodiment of a resource recovery system.

The detailed description explains embodiments of the invention, together with advantages and features, by way of example with reference to the drawings.

### DETAILED DESCRIPTION OF THE INVENTION

Shown in the FIGURE is an embodiment of a resource recovery system 10. The system 10 is located at a desired regolith surface 12, such as on Earth, the Moon, an asteroid, or another planet. A capture container 14 is placed over the surface 12 to be scavenged for resources defining a capture volume 30 between the surface 12 and an interior of the capture container 14. In some embodiments, the capture container 14 is fitted to the surface 12, either through flexibility of the container 14 or other means, such as a seal, to control leakage of recovered resources from an interior 16 of the capture container 14.

One or more hole making devices 18, such as, for example, an auger, spike, rod, impactor, is located in the interior of the capture container 14. While only one hole making device 18 is shown in the FIGURE, it is to be appreciated that other quantities of hole making devices 18, for example 2, 3, or 4 or more hole making devices 18 may be utilized to increase a rate of resource recovery into the capture container 14. The hole making device 18 is utilized to make a hole 20 in the surface 12 and pull excavated soil 22 from the hole 20 to the surface 12.

One or more energy emitters 24 are located in the capture container 14. The emitters 24 may be, for example, microwave emitters or concentrated solar energy emitters. Energy 26 emitted by the emitters 24 is directed toward the excavated soil 22, thereby heating the excavated soil 22. Heating of the excavated soil 22 releases desirable resources and/or compounds in the excavated soil 22 in the form of gases and/or liquids into the capture container 14. The resources are removed from the capture container 14 by a collection device 28 for further processing as necessary. The collection device 28 may be, for example, a cold plate, still, turbopump, or other collection device 28. Further, in some embodiments, the system 10 is disposed on a moveable structure, for example a cart 32, so that when resource scavenging is completed at one site, the system 10 is easily movable to a second site for additional resource scavenging and recovery.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A resource recovery system comprising:
a capture container defining a capture volume between a desired surface and an interior of the capture container;
one or more hole making devices disposed in the capture container configured to excavate soil from at least one hole in the desired surface; and
one or more energy emitters configured to direct energy toward the excavated soil to heat the excavated soil thereby releasing one or more compounds;
wherein the capture container is configured to capture gas and/or liquid compounds released from the excavated soil.

2. The system of claim 1, wherein the one or more hole making devices are one or more augers.

3. The system of claim 1, wherein the one or more hole making devices are one or more spikes, rods, or impactors.

4. The system of claim 1, wherein the one or more energy emitters are one or more microwave emitters.

5. The system of claim 1, wherein the one or more energy emitters are one or more solar energy emitters.

6. The system of claim 1, further comprising a collection device to remove the compounds from the capture container.

7. The system of claim 6, wherein the collection device is one of a cold plate, a still, or a turbopump.

8. The system of claim 1, wherein the compounds are in liquid or gaseous form.

9. The system of claim 1, wherein the desired surface comprises regolith.

10. The system of claim 1, wherein the system is secured to a movable cart.

11. A method of resource extraction from soil comprising:
covering a desired surface with a capture container defining a capture volume between the desired surface and an interior of the capture container;
excavating soil from a hole in the desired surface into the capture volume; and
heating the excavated soil via one or more energy emitters thereby releasing one or more compounds into the capture volume.

12. The method of claim 11, further comprising removing the compounds from the capture volume via a collection device.

13. The method of claim 12, wherein the collection device is one of a cold plate, a still, or a turbopump.

14. The method of claim 11, further comprising excavating soil from the hole via an auger.

15. The method of claim 11, further comprising heating the excavated soil via one or more microwave emitters.

16. The method of claim 11, further comprising heating the excavated soil via one or more solar energy emitters.

17. The method of claim 11, wherein the compounds are in liquid or gaseous form.

18. The method of claim 11, wherein the desired surface comprises regolith.
